(19) United States
(12) Patent Application Publication
(10) Pub. No.: US 2016/0088106 A1
(43) Pub. Date: Mar. 24, 2016

(54) METHOD AND APPARATUS OF PROCESSING A DOI (DIGITAL OBJECT UNIQUE IDENTIFIER) IN INTERACTION INFORMATION

(71) Applicant: Alibaba Group Holding Limited, Grand Cayman (KY)

(72) Inventors: Bicai Wang, Chengdu (CN); Xiang Zhang, Chengdu (CN)

(21) Appl. No.: 14/860,449

(22) Filed: Sep. 21, 2015

(30) Foreign Application Priority Data
Sep. 22, 2014 (CN) 201410487306.4

(51) Int. Cl. H04L 29/08; H04L 12/58; G06F 3/0484

(52) U.S. Cl. CPC H04L 67/26; G06F 3/0484; H04L 51/18

(57) ABSTRACT

A method of processing a DOI in interaction information to improve user efficiency in acquiring information identified by the DOI is disclosed. The method includes acquiring, by a server, a digital object unique identifier (DOI) in interaction information; parsing the DOI to acquire information identified by the DOI; and pushing the information identified by the DOI to a client end, so that the client end displays the information identified by the DOI in an information interactive interface. An apparatus of processing a DOI in interaction information is also disclosed.

### CROSS REFERENCE TO RELATED PATENT APPLICATION

This application claims foreign priority to Chinese Patent Application No. 201410487306.4 filed on Sep. 22, 2014, entitled “Method and Apparatus of Processing a DOI in Interaction Information”, which is hereby incorporated by reference in its entirety.

### TECHNICAL FIELD

The present disclosure relates to the field of computer and Internet technologies, and in particular, to methods and apparatuses of processing a DOI (Digital Object Unique Identifier) in interaction information.

### BACKGROUND

In an information age having a rapid development of science and technology, interaction of information occurs frequently, and interaction information may include a large amount of textual information, image information, link information or audio/video information. In particular, a Digital Object Unique Identifier (DOI) may also exist in the interaction information. As an “identification card” number in a digital age, the DOI mainly includes types such as a two-dimensional code (also known as QR code), a bar code, a character code, a network domain name, etc.

Information interaction in Instant Messaging (IM for abbreviation) is used as an example. A client end A receives a two-dimensional code image sent from a client end B. In order to obtain information identified by a two-dimensional code in a two-dimensional code image, a user of the client end A needs to store the two-dimensional code image received by the client end A locally, exit from an IM interface, open a two-dimensional code scanning software, and load the two-dimensional code image that has been locally stored into the two-dimensional code scanning software. After the two-dimensional code scanning software completes an analysis of the two-dimensional code image, the users may read the information identified by the two-dimensional code from an interface of the two-dimensional code scanning software.

Deficiencies exist in the above existing technologies. In order to obtain information identified by a two-dimensional code in interaction information, a user needs to perform multiple operations, which results in relatively tedious operations and low efficiency of operations.

Similarly, the aforementioned technical problem still exists if the user wants to acquire other types of information identified by the DOI, such as a bar code, which is included in the interaction information.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method of processing a DOI in interaction information to improve the efficiency of obtaining information identified by the DOI for a user.

The embodiments of the present disclosure further provide an apparatus of processing a DOI in interaction information to improve the efficiency of obtaining information identified by the DOI for a user.

The embodiments of the present disclosure employ technical solutions as follows.

A method of processing a DOI in interaction information, which includes a server obtaining a digital object unique identifier (DOI) in interaction information; analyzing the DOI to obtain information identified by the DOI; and pushing the information identified by the DOI to a client end to enable the client end to display the information identified by the DOI in an information interactive interface.

A method of processing a DOI in interaction information, which includes an instant messaging client end obtaining a DOI in interaction information; analyzing the DOI to acquire information identified by the DOI; and displaying the information identified by the DOI in an information interactive interface.

An apparatus of processing a DOI in interaction information, which includes an acquisition unit to acquire a DOI in interaction information; an analysis unit to analyze the DOI to acquire information identified by the DOI; and a push unit to push the information identified by the DOI to a client end to enable the client end to display the information identified by the DOI in an information interactive interface.

An apparatus of processing a DOI in interaction information, which includes an acquisition unit to acquire a DOI in interaction information; an analysis unit to analyze the DOI to acquire information identified by the DOI; and a display unit to display the information identified by the DOI in an information interactive interface.

From the technical solutions of the embodiments of the present disclosure, a user is able to acquire information identified by a DOI in interaction information without performing tedious operations during an interaction of information, and thus user efficiency of obtaining the information that is identified by the DOI is greatly increased as compared to the existing technologies.

### BRIEF DESCRIPTION OF THE DRAWINGS

The accompanying drawings described herein are provided for further comprehension of the present disclosure, and constitute a part of the present disclosure. Exemplary embodiments of the present disclosure and a description thereof are used to illustrate the present disclosure, and do not constitute any limitation to the present disclosure. In the accompanying drawings:

FIG. 1A is a flowchart illustrating an example method of processing a DOI in interaction information in accordance with the embodiments of the present disclosure.

FIG. 1B is a schematic diagram illustrating a name card image including a two-dimensional code in accordance with the embodiments of the present disclosure.

FIG. 1C is a schematic diagram illustrating a change in state of information identified by a two-dimensional code displayed in an information interactive interface in accordance with the embodiments of the present disclosure.

FIG. 2 is a flowchart illustrating another example method of processing a DOI in interaction information in accordance with the embodiments of the present disclosure.

FIG. 3 is a flowchart illustrating another example method of processing a DOI in interaction information in accordance with the embodiments of the present disclosure.

FIG. 4 is a structural diagram illustrating an apparatus of processing a DOI in interaction information in accordance with the embodiments of the present disclosure.

FIG. 5 is a structural diagram illustrating another apparatus of processing a DOI in interaction information in accordance with the embodiments of the present disclosure.

### DETAILED DESCRIPTION

In order to make objectives, technical solutions, and advantages of embodiments of the present disclosure more comprehensible, technical solutions of the present disclosure are clearly and fully described hereinafter with reference to exemplary embodiments and corresponding accompanying drawings of the present disclosure. Apparently, the described embodiments represent merely a part of and not all of the embodiments of the present disclosure. All other embodiments acquired by one of ordinary skill in the art based on the embodiments of the present disclosure without making any creative effort shall belong to the scope of protection of the present disclosure.

The technical solutions provided by the embodiments of the present disclosure are described in detail herein with reference to the accompanying drawings.

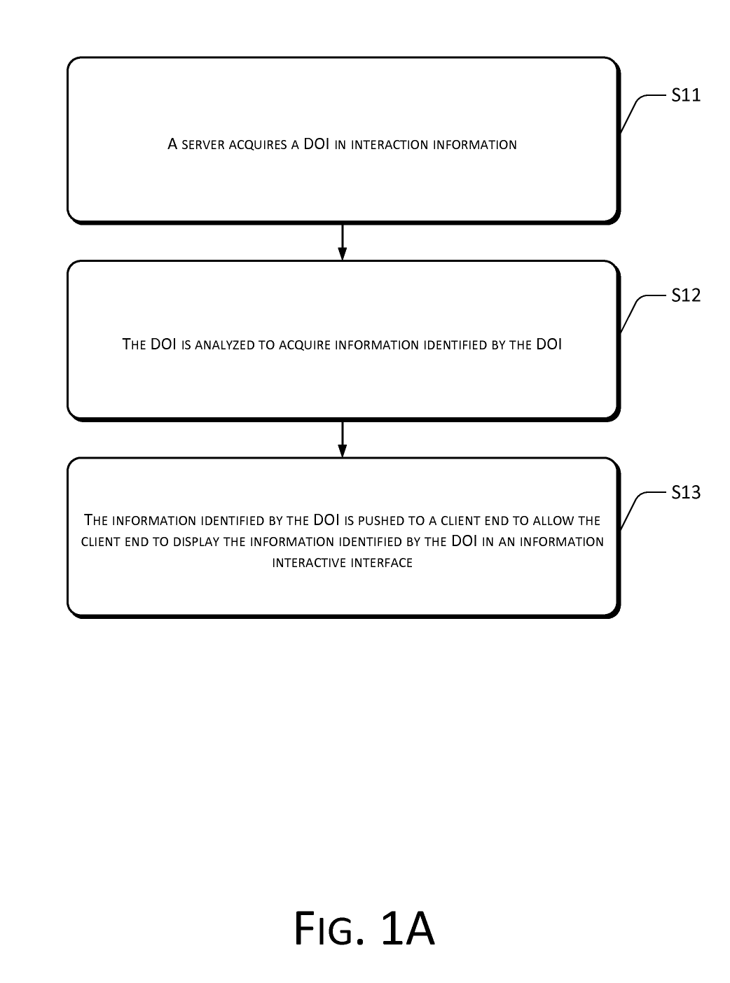

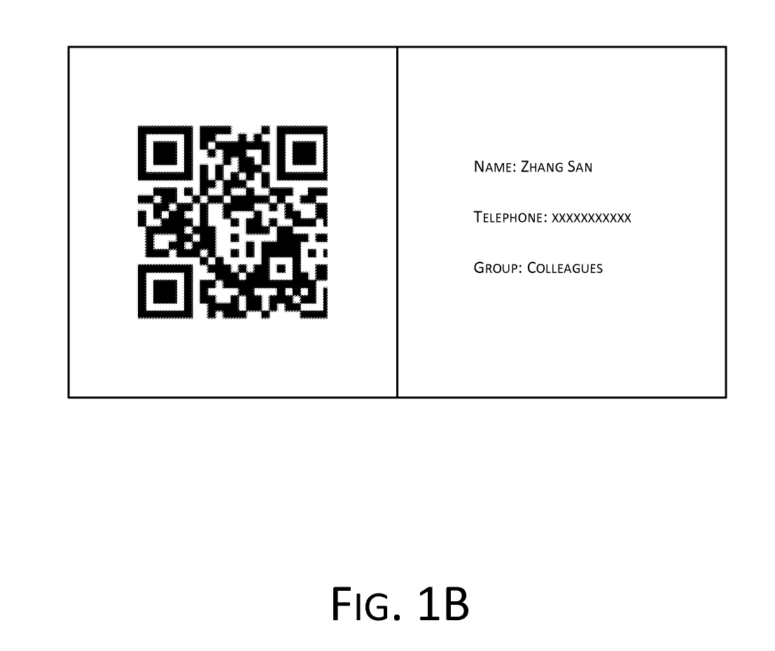

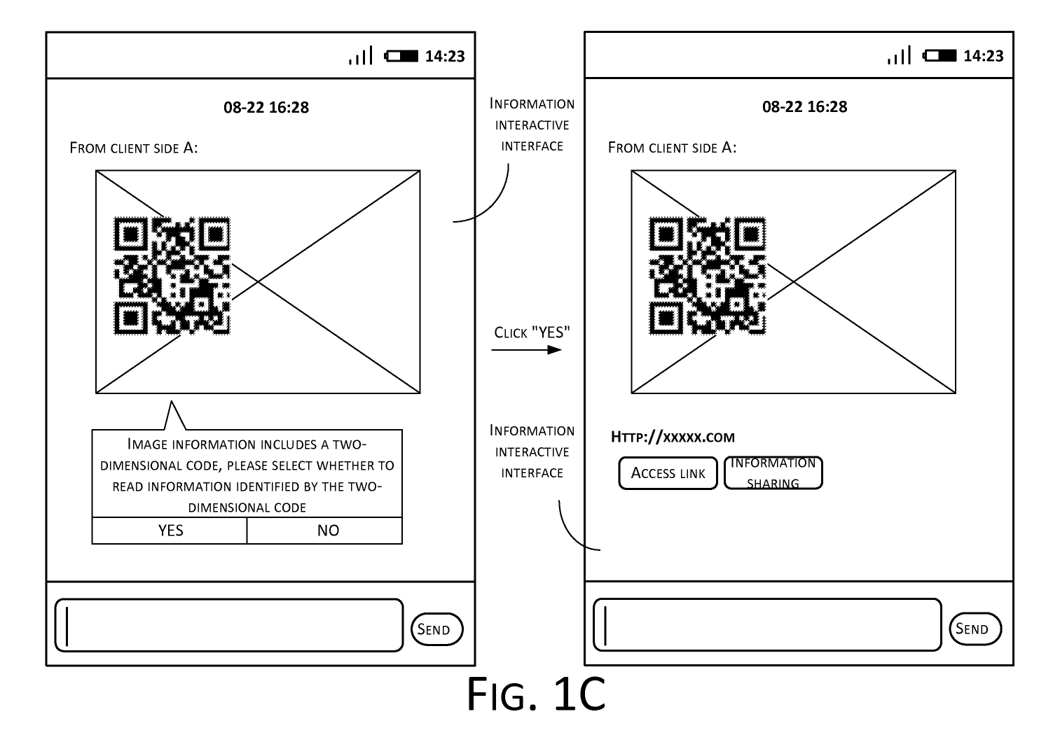

The embodiments provide a method of processing a DOI in interaction information. An example flowchart of the method is shown in FIG. 1A, which includes the following method blocks.

At S11, a server acquires a DOI in interaction information.

At S12, the DOI is analyzed to acquire information identified by the DOI.

At S13, the information identified by the DOI is pushed to a client end to allow the client end to display the information identified by the DOI in an information interactive interface.

At S11, no limitation is imposed on a type of the interaction information. For example, the interaction information may be interaction information in instant messaging (e.g., QQ, WeChat, Fetion, IP Messenger, MSN Messenger, Baidu HI, Sina UC, etc.), interaction information in a social networking platform (e.g., MicroBlog, Twitter, Facebook, Tianya Club, etc.), interaction information in an electronic mail, etc. The interaction information includes a DOI, and may further include textual information, image information, link information, audio/video information, etc. As a digital object unique identifier, the DOI possesses uniqueness, and thus information uniquely identified by the DOI is able to be obtained based on a corresponding analysis rule. No limitation is imposed on a type of the DOI, which may be a two-dimensional code, a bar code, a character code, a network domain name, etc., for example.

At S12, an implementation of analyzing the DOI to acquire information identified by the DOI may be achieved in the following mode: a DOI coding and decoding processor is integrated in the server, and correspondingly identified information may be parsed from the DOI according to a DOI logic coding and decoding rule.

At S13, the information identified by the DOI may be pushed to a receiving client end (i.e., a client end that receives the interaction information) only or a sending client end (i.e., a client end that sends the interaction information) only. Alternatively, the information identified by the DOI may be pushed to the receiving client end and the sending client end respectively, which is not specifically limited herein.

In an implementation, S11 may include obtaining the DOI in the interaction information that is sent by a sending client end. At S13, the information identified by the DOI may be pushed to the receiving client end of the receiver and/or the sending client end of the sender at the same time.

In an implementation, S13 may include pushing interaction information that includes the information identified by the DOI to the client end. It can be understood that either the interaction information that includes both the DOI and the information identified by the DOI or the interaction information that only includes the information identified by the DOI can be pushed to the client end. In this way, when the server sends interaction information sent by a sending client end to a receiving client end, the server may send information identified by a parsed DOI in interaction information, together with the interaction information to the receiving client end, so that the receiving client end of the receiver may acquire the information identified by the DOI in the interaction information directly.

In an implementation, S11 may include the following method sub-blocks:
obtaining image information in the interaction information; and
determining whether the image information includes the DOI, and extracting the DOI from the image information if affirmative.

Image information may include a DOI, and may also include information other than the DOI. This implementation is able to automatically identify image information that includes a DOI and extract the DOI therefrom. As shown in FIG. 1B, an image includes text content in addition to a two-dimensional code that identifies a company website. Using the foregoing method sub-blocks, a name card image that includes the two-dimensional code is automatically identified, from which the two-dimensional code is extracted.

In an implementation, the DOI in the interaction information may also be embodied in a form other than an image, for example, a two-dimensional code pattern presented by an arrangement of multiple “▪” symbols and spaces according to a certain rule.

In an implementation, S13 may include pushing a display operation entry for the information identified by the DOI to the client end; and pushing the information identified by the DOI to the client end in response to receiving a display trigger instruction for the information identified by the DOI from the client end, where the display trigger instruction is triggered by a user operation on the display operation entry.

The display operation entry is an operation entry for a user to select whether to display the information identified by the DOI, and may include a window, a button, etc. As shown by the left-side view in FIG. 1C, when a client end B receives image information including a two-dimensional code that is sent by a client end A through the server, a prompt window may show up below the image information to indicate to a user that the image information includes a two-dimensional code, and ask the user whether to read information identified by the two-dimensional code. If the user clicks on a “YES” button, the prompt window is closed, and the information identified by the two-dimensional code is displayed in the information interactive interface, as shown by the right-side view in FIG. 1C. If the user clicks on a “NO” button in the left-side view of FIG. 1C, the prompt window is closed, and the information identified by the two-dimensional code will not be displayed in the information interactive interface.

In the foregoing implementation, a user is able to select whether to read the information identified by the DOI based on his/her needs. When reading the information identified by the DOI is not desired, the information identified by the DOI will not be displayed in the information interactive interface, thus reducing loading of data to save network traffic resources of a mobile terminal. On the other hand, if the information identified by the DOI is not a secure website link, this solution is able to reduce a potential risk and loss due to an automatic link to an unsecure website for the user.

In another implementation, if the information identified by the DOI is detected in advance to be safe information, the display operation entry for the information identified by the DOI may be not pushed to the client end. Instead, the information identified by the DOI may be pushed to the client end directly.

In an implementation, the DOI processing method may further include pushing an operation entry for the information identified by the DOI to the client end.

As shown by the right-side view of FIG. 1C, the operation entry for the information identified by the two-dimensional code includes an operation entry for link access (i.e., an “Access link” button) and an operation entry for sharing information (i.e., an “Information sharing” button) when the information identified by the two-dimensional code is a website link. In addition, the operation entry for the information identified by the DOI may also be an operation entry for copying information, an operation entry for collecting information, an operation entry for forwarding information, etc. The operation entry for the information identified by the DOI may include a window, a button, etc.

From the technical solutions of the foregoing embodiments, a user is able to acquire information identified by a DOI in interaction information without performing complicated operations during information interaction. Therefore, these solutions greatly improve the efficiency of acquiring the information identified by the DOI for the user as compared to the existing technologies.

It should be noted that an entity that performs the method blocks of the method provided in the embodiments may be a same device or may be a plurality of different devices. For example, S11 and S12 may be performed by a first server device, and S13 may be performed by a second server device. For another example, S11 may be performed by a first server device, whereas S12 and S13 may be performed by a second server device, etc.

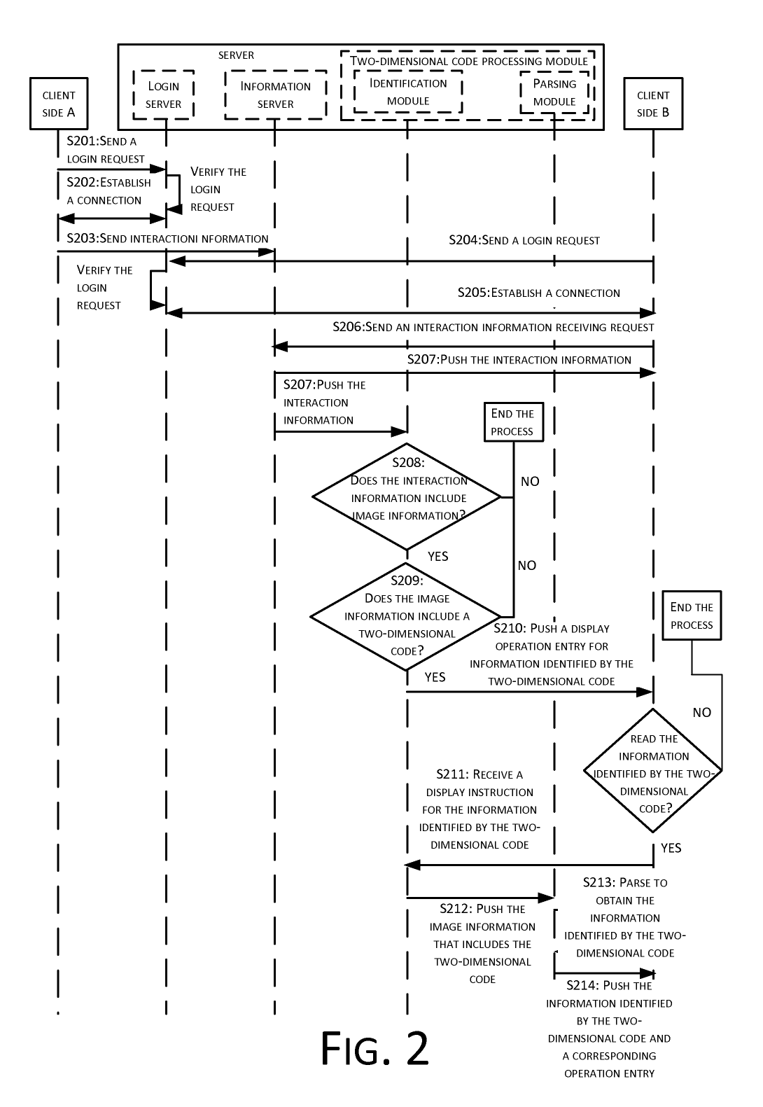

The embodiments provide another method of processing a DOI in interaction information. This method is applicable in instant messaging, and the DOI is a two-dimensional code. A server is divided into a login server, an information server and a two-dimensional code processing module. The two-dimensional code processing module may include an identification module and a scanning module. With reference to FIG. 2, an exemplary process of the method includes method blocks as follows.

At S201, the login server receives a login request sent by a client end A.

At S202, the login server establishes a connection with the client end A upon verifying the login request of the client end A.

At S203, the information server receives and stores interaction information sent by the client end A, where the interaction information includes textual information and image information, and the image information includes a two-dimensional code.

At S204, the login server receives a login request sent by a client end B.

At S205, the login server establishes a connection with the client end B upon verifying the login request of the client end B.

At S206, the information server receives an interaction information receiving request from the client end B.

At S207, the information server pushes the interaction information to the client end B and the identification module.

At S208, the identification module determines whether the interaction information includes image information. S209 is performed if affirmative. Otherwise, the process is ended.

At S209, the identification module determines whether the image information includes a two-dimensional code. S210 is performed if affirmative. Otherwise, the process is ended.

At S210, the identification module pushes a display operation entry for information identified by the two-dimensional code to the client end B to ask a user of the client end B whether to read the information identified by the two-dimensional code.

At S211, the identification module receives a display instruction for the information identified by the two-dimensional code from the client end B.

At S212, the identification module pushes the image information that includes the two-dimensional code to the scanning module.

At S213, the scanning module scans and parses the image information that includes the two-dimensional code according to a defined parsing rule to acquire the information identified by the two-dimensional code.

At S214, the scanning module pushes the information identified by the two-dimensional code and an operation entry for the information identified by the two-dimensional code to the client end B.

After S214, the user of the B client end is able to acquire the information identified by the two-dimensional code from an information interactive interface of instant messaging, and may perform a related operation on the information identified by the two-dimensional code via a corresponding operation entry, e.g., copying the information identified by the two-dimensional code by clicking on a “Copy” button, or accessing a webpage of a website link by clicking on an “Access link” button if the information identified by the two-dimensional code includes the website link.

At S210, the identification module may also push a display operation entry for the information identified by the two-dimensional code to the client end A at the same time to ask a user of the client end A whether to read the information identified by the two-dimensional code. Correspondingly, the scanning module may push the information identified by the two-dimensional code and the operation entry for the information identified by the two-dimensional code to the client end A at the same time at S214. In this way, the user of the client end A is also able to selectively view the information identified by the two-dimensional code in the image information that has been sent, thus having a very convenient operation.

In the embodiments of the present disclosure, interaction(s) between the client end A and the client end B may be different from the above method blocks. For example, when the client end A sends interaction information to the client end B, the client end A may directly send the interaction information to the server. The server may parse the two-dimensional code from the interaction information to acquire information identified thereby, and include the two-dimensional code in interaction information that is directly forwarded to the client end B. No limitation is imposed on any similar implementations, as long as the server is able to parse a DOI included in interaction information and provide information identified to a client end after parsing in a convenient manner.

For interaction(s) of information in a social networking platform or via electronic mails, a process of processing a DOI is similar to the foregoing process, and is not repeatedly described in detail herein.

As can be seen from the foregoing process, a user is able to acquire information identified by a two-dimensional code in interaction information without performing tedious operations during information interaction. Thus, this solution greatly increases the user efficiency of obtaining the information that is identified by the two-dimensional code as compared to the existing technologies.

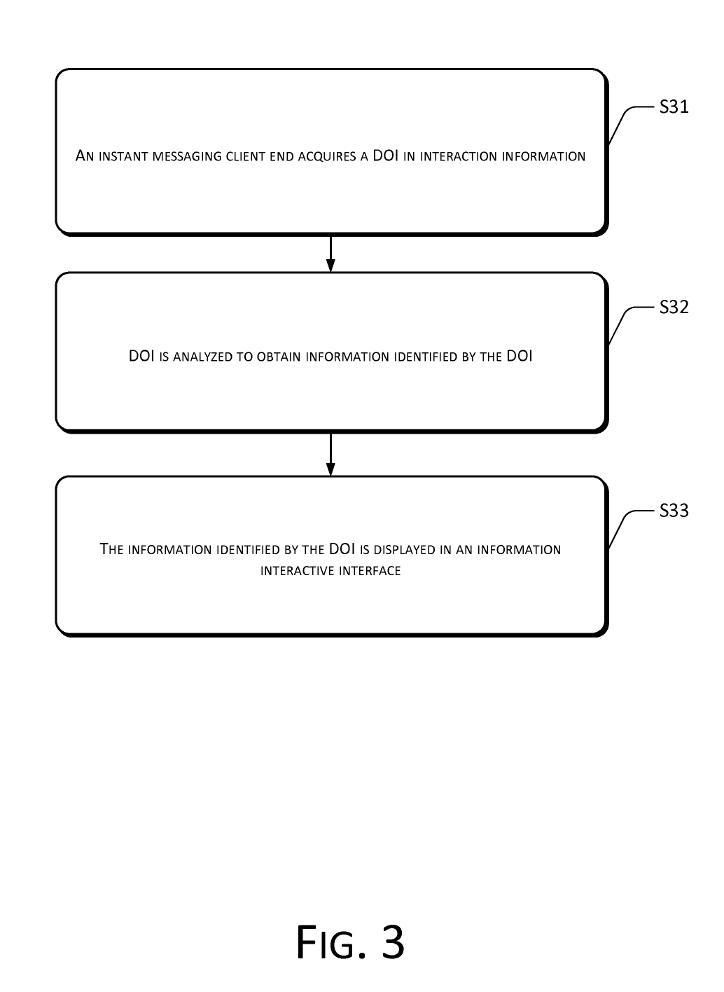

The embodiments further provide another method of processing a DOI in interaction information. An exemplary flowchart of this method is shown in FIG. 3, which includes method blocks as follows.

At S31, an instant messaging client end acquires a DOI in interaction information.

At S32, DOI is analyzed to obtain information identified by the DOI.

At S33, the information identified by the DOI is displayed in an information interactive interface.

Unlike the forgoing embodiments, the method blocks in this embodiment are performed by an IM client end, which may be a sending client end or a receiving client end. A DOI coding and decoding processor may be integrated in the IM client end, and the DOI coding and decoding processor may parse correspondingly identified information from the DOI as according to a DOI logic coding and decoding rule. In addition, the IM client end may also access a server which is integrated with a DOI coding and decoding processor, and parse the DOI through the server to acquire information correspondingly identified by the DOI.

In an implementation, S31 may include method sub-blocks as follows:
obtaining image information in the interaction information; and
determining whether the image information includes the DOI, and extracting the DOI from the image information if affirmative.

In an implementation, S33 may include pushing a display operation entry for the information identified by the DOI to the information interactive interface; and displaying the information identified by the DOI in the information interactive interface in response to receiving a display trigger instruction for the information identified by the DOI, where the display trigger instruction is triggered by a user operation on the display operation entry.

In an implementation, the DOI processing method may further include displaying an operation entry for the information identified by the DOI in the information interactive interface.

By the same token, a user is able to obtain information identified by a DOI in interaction information without performing complicated operations in information interaction, thus having a relatively high efficiency.

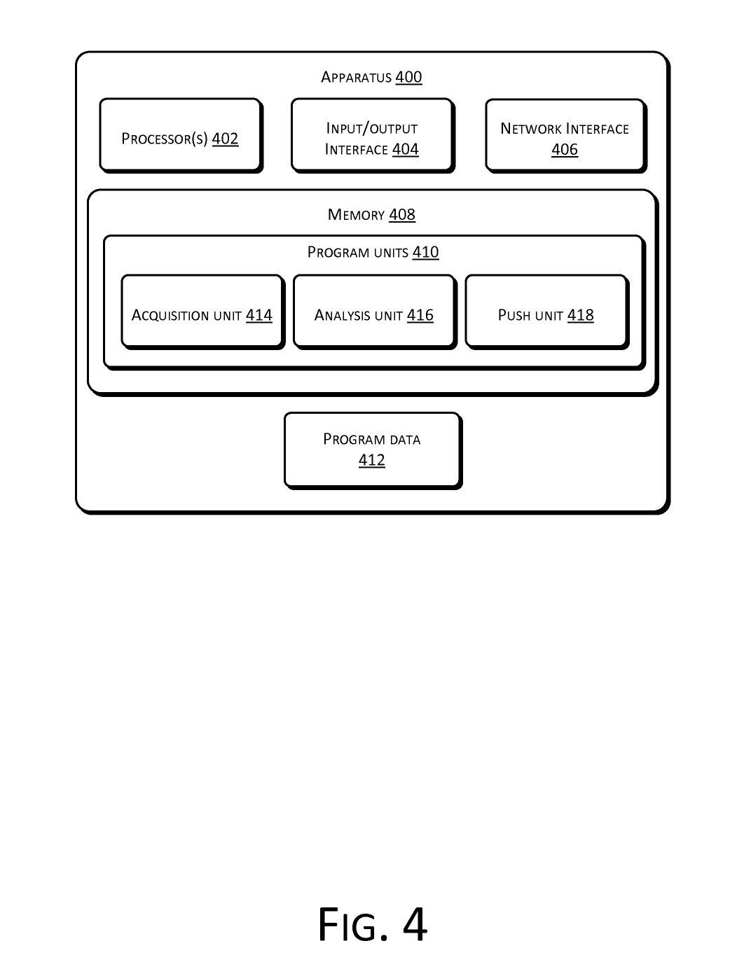

Based on the same inventive concepts, the embodiments provide an apparatus of processing a DOI in interaction information. The apparatus may include one or more computing devices. For example, in an implementation, the apparatus 400 may include one or more processors 402, an input/output (I/O) interface 404, a network interface 406 and memory 408 as shown in FIG. 4.

The memory 408 may include a form of computer readable media such as volatile memory, Random Access Memory (RAM), and/or non-volatile memory, e.g., Read-Only Memory (ROM) or flash RAM, etc. The memory 408 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an embodiment, the memory 408 may include program units 410 and program data 412. The program units 410 may include an acquisition unit 414 to obtain a DOI from interaction information; an analysis unit 416 to analyze the DOI to obtain information identified by the DOI; and a push unit 418 to push the information identified by the DOI to a client end to cause the client end to display the information identified by the DOI in an information interactive interface.

In an implementation, the acquisition unit 414 may obtain the DOI in the interaction information that is sent by a sending client end.

In an implementation, the push unit 418 may push interaction information that includes information identified by the DOI to the client end.

In an implementation, the acquisition unit 414 may obtain image information from the interaction information, determine whether the image information includes the DOI, and extract the DOI from the image information if affirmative.

In an implementation, the push unit 418 may push a display operation entry for the information identified by the DOI to the client end, and push the information identified by the DOI to the client end in response to receiving a display trigger instruction for the information identified by the DOI sent by the client end, where the display trigger instruction is triggered by a user operation on the display operation entry.

In an implementation, the push unit 418 may also push an operation entry for the information identified by the DOI to the client end.

In the foregoing implementations, the interaction information may include interaction information in instant messaging, interaction information in a social networking platform, interaction information in an electronic mail, etc.

According to the technical solutions of the embodiments, a user is able to acquire information identified by a two-dimensional code in interaction information without performing tedious operations during information interaction. Thus, this solution greatly increases the user efficiency of obtaining the information that is identified by the two-dimensional code as compared to the existing technologies.

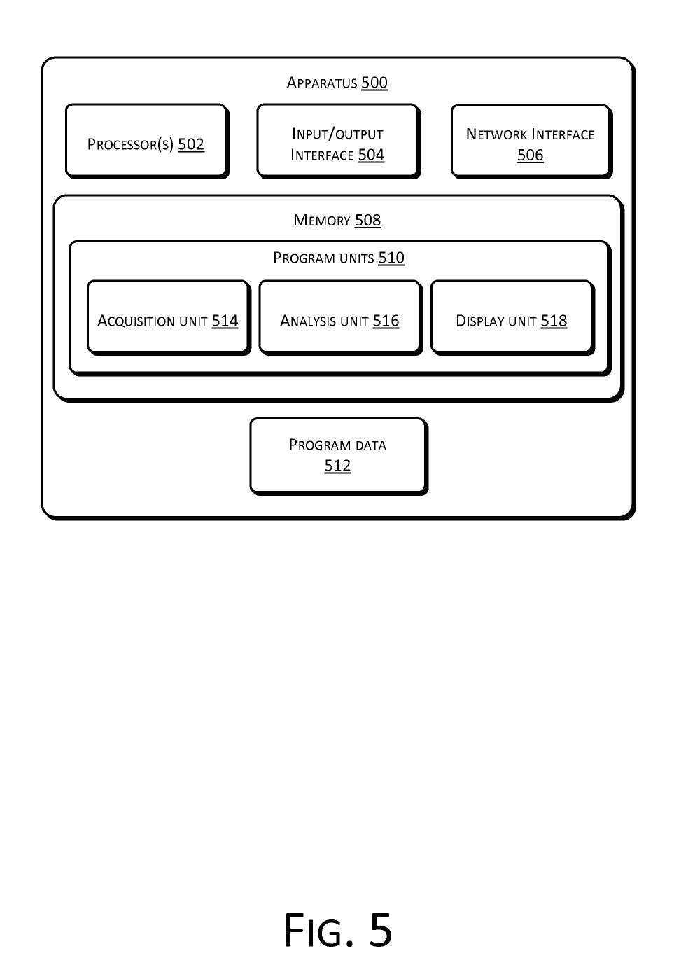

Based on the same inventive concepts, the embodiments provide another apparatus of processing a DOI in interaction information. The apparatus may include one or more computing devices. For example, in an implementation, the apparatus 500 may include one or more processors 502, an I/O interface 504, a network interface 506 and memory 508 as shown in FIG. 5. The memory 508 may include a form of computer readable media as described in the foregoing description.

In an implementation, the memory 508 may include program units 510 and program data 512. The program units 510 may include an acquisition unit 514 to obtain a DOI from interaction information; an analysis unit 516 to parse the DOI to obtain information identified by the DOI; and a display unit 518 configured to display the information identified by the DOI in an information interactive interface.

In an implementation, the acquisition unit 514 may obtain image information from the interaction information, determine whether the image information includes the DOI, and extract the DOI from the image information if affirmative.

In an implementation, the display unit 518 may push a display operation entry for the information identified by the DOI to the information interactive interface, and display the information identified by the DOI in the information interactive interface in response to receiving a display trigger instruction for the information identified by the DOI, where the display trigger instruction is triggered by a user operation on the display operation entry.

In an implementation, the display unit 518 may further display an operation entry for the information identified by the DOI in the information interactive interface.

By the same token, a user is able to acquire information identified by a two-dimensional code in interaction information without performing tedious operations during information interaction. Thus, this solution greatly increases the user efficiency of obtaining the information that is identified by the two-dimensional code as compared to the existing technologies.

One skilled in the art should understand that the embodiments of the present disclosure can be provided as a method, a system or a product of a computer program. Therefore, the present disclosure can be implemented as an embodiment of hardware only, an embodiment of software only, or an embodiment of a combination of hardware and software. Moreover, the present disclosure can be implemented as a product of a computer program that can be stored in one or more computer readable storage media (which includes but is not limited to, a magnetic disk, a CD-ROM or an optical disk, etc.) that store computer-executable instructions.

The present disclosure is described in accordance with flowcharts and/or block diagrams of the exemplary methods, apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate a computer implemented process. Therefore, the instructions executed by the computer or the other programmable apparatus may be used to implement one or more processes of the flowcharts and/or one or more blocks of the block diagrams.

It should also be noted that terms such as “comprise”, “include” or any other variations thereof are meant to cover the non-exclusive inclusions. The process, method, product or apparatus that includes a series of elements not only includes those elements, but also includes other elements that are not explicitly listed, or further includes elements that already existed in such process, method, product or apparatus. In a condition without further limitations, an element defined by the phrase “include a/an . . . ” does not exclude any other similar elements from existing in the process, method, product or apparatus.

One skilled in the art should understand that the embodiments of the present disclosure can be provided as a method, a system or a computer program product. Therefore, the present disclosure can be implemented as an embodiment of only hardware, an embodiment of only software or an embodiment of a combination of hardware and software. Moreover, the present disclosure can be implemented as a computer program product that may be stored in one or more computer readable storage media (which includes but is not limited to, a magnetic disk, a CD-ROM or an optical disk, etc.) that store computer-executable instructions.

The above descriptions are merely exemplary embodiments of the present disclosure, and are not intended to limit the present disclosure. For one skilled in the art, the present disclosure may have various modifications and changes. Any modifications, equivalent replacements and improvements, etc., made within the spirit and principle of the present disclosure should be included in the scope of protection of the claims in the present disclosure.

What is claimed is:

1. A method implemented by one or more computing devices, the method comprising:
obtaining a digital object unique identifier (DOI) from interaction information;
analyzing the DOI to obtain information identified by the DOI; and
pushing the information identified by the DOI to a client end to cause the client end to display the information identified by the DOI in an information interactive interface.

2. The method of claim 1, wherein the DOI in the interaction information is sent from a sending client end.

3. The method of claim 1, wherein pushing the information identified by the DOI to the client end comprises pushing new interaction information that includes the information identified by the DOI to the client end.

4. The method of claim 1, wherein obtaining the DOI from the interaction information comprises:
obtaining image information from the interaction information;
determining whether the image information includes the DOI; and
extracting the DOI from the image information in response to determining that the image information includes the DOI.

5. The method of claim 1, wherein pushing the information identified by the DOI to the client end comprises:
pushing a display operation entry for the information identified by the DOI to the client end; and
pushing the information identified by the DOI to the client end in response to receiving a display trigger instruction for the information identified by the DOI from the client end, wherein the display trigger instruction is triggered by a user operation on the display operation entry.

6. The method of claim 1, further comprising pushing an operation entry for the information identified by the DOI to the client end.

7. The method of claim 1, wherein the interaction information comprises interaction information in instant messaging, interaction information in a social networking platform or interaction information in an electronic mail.

8. The method of claim 1, wherein the DOI comprises a two-dimensional code, a bar code, a character code or a network domain name.

9. The method of claim 1, further comprising:
determining whether the information identified by the DOI is safe prior to pushing the information identified by the DOI to the client end; and
pushing the information identified by the DOI to the client end in response to determining that the information identified by the DOI is safe.

10. One or more computer-readable media storing executable instructions that, when executed by one or more processors, cause the one or more processors to perform acts comprising:
obtaining a digital object unique identifier (DOI) from interaction information;
analyzing the DOI to obtain information identified by the DOI; and
pushing the information identified by the DOI to a client end to cause the client end to display the information identified by the DOI in an information interactive interface.

11. The one or more computer-readable media of claim 10, wherein pushing the information identified by the DOI to the client end includes pushing new interaction information that includes the information identified by the DOI to the client end.

12. The one or more computer-readable media of claim 10, wherein obtaining the DOI from the interaction information comprises:
obtaining image information from the interaction information;
determining whether the image information includes the DOI; and
extracting the DOI from the image information in response to determining that the image information includes the DOI.

13. The one or more computer-readable media claim 10, wherein pushing the information identified by the DOI to the client end comprises:
pushing a display operation entry for the information identified by the DOI to the client end; and
pushing the information identified by the DOI to the client end in response to receiving a display trigger instruction for the information identified by the DOI from the client end, wherein the display trigger instruction is triggered by a user operation on the display operation entry.

14. The one or more computer-readable media claim 10, the acts further comprising pushing an operation entry for the information identified by the DOI to the client end.

15. The one or more computer-readable media claim 10, wherein the interaction information comprises interaction information in instant messaging, interaction information in a social networking platform or interaction information in an electronic mail.

16. The one or more computer-readable media claim 10, the acts further comprising:
determining whether the information identified by the DOI is safe prior to pushing the information identified by the DOI to the client end; and
pushing the information identified by the DOI to the client end in response to determining that the information identified by the DOI is safe.

17. An apparatus comprising:
one or more processors;
memory;
an acquisition unit stored in the memory and executable by the one or more processors to obtain a digital object unique identifier (DOI) from interaction information;
an analysis unit stored in the memory and executable by the one or more processors to parse the DOI to obtain information identified by the DOI; and
a display unit stored in the memory and executable by the one or more processors to display the information identified by the DOI in an information interactive interface.

18. The apparatus of claim 17, wherein the acquisition unit further obtains image information from the interaction information, determines whether the image information includes the DOI, and extracts the DOI from the image information in response to determining that the image information includes the DOI.

19. The apparatus of claim 17, wherein the display unit further pushes a display operation entry for the information identified by the DOI to the information interactive interface; and display the information identified by the DOI in the information interactive interface in response to receiving a display trigger instruction for the information identified by the DOI, wherein the display trigger instruction is triggered by a user operation on the display operation entry.

20. The apparatus of claim 17, wherein the interaction information comprises interaction information in instant messaging, interaction information in a social networking platform or interaction information in an electronic mail, and wherein the DOI comprises a two-dimensional code, a bar code, a character code or a network domain name.
